(19) United States
(12) Patent Application Publication
(10) Pub. No.: US 2012/0157029 A1
(43) Pub. Date: Jun. 21, 2012

(54) ANTENNA SWITCH CIRCUIT AND METHOD OF SWITCHING THE SAME

(75) Inventor: Shuji MATSUURA, Suwon (KR)

(73) Assignee: SAMSUNG ELECTRO-MECHANICS CO., LTD.

(21) Appl. No.: 13/330,143

(22) Filed: Dec. 19, 2011

(30) Foreign Application Priority Data
Dec. 21, 2010 (KR) 10-2010-0131867

(51) Int. Cl. H04B 1/06

(52) U.S. Cl. 455/253.2

(57) ABSTRACT

There are provided an antenna switch circuit including: a first filter 110 passing a first broadcasting signal having a predetermined band among broadcasting signals passing through a first input terminal IN1; a second filter 120 passing a second broadcasting signal having a predetermined band among broadcasting signals passing through a second input terminal IN2; a first amplifier 310 amplifying or bypassing the first broadcasting signal of the first filter 110; a second amplifier 320 amplifying or bypassing the second broadcasting signal of the second filter 120; and a signal level attenuator 500 attenuating levels of the first broadcasting signal of the first amplifier 310 and the second broadcasting signal of the second amplifier 320 to have predetermined levels.

### CROSS-REFERENCE TO RELATED APPLICATIONS

This application claims the priority of Korean Patent Application No. 10-2010-0131867 filed on Dec. 21, 2010, in the Korean Intellectual Property Office, the disclosure of which is incorporated herein by reference.

### BACKGROUND OF THE INVENTION

1. Field of the Invention

The present invention relates to an antenna switch circuit and a method of switching the same which can be applied to a television broadcast receiving system, and more particularly, to an antenna switch circuit and a method of switching the same in which the isolation between two broadcasting signals can be improved in a television broadcast receiving system.

2. Description of the Related Art

Recently, as digital broadcasting services have been initiated, analog television broadcasting has been converted to digital television broadcasting and the conversion to digital broadcasting is already in progress in cable television broadcasting or satellite television broadcasting.

In addition, as a receiver receiving digital broadcasting, attention to and research into a television receiver capable of selectively receiving one of two television broadcasts is accelerating.

The television receiver may include an antenna switch circuit selecting one of two different broadcasting signals.

For example, a known antenna switch circuit includes a first filter passing a first broadcasting signal, a second filter passing a second broadcasting signal, a selector selecting one signal of the first broadcasting signal from the first filter and the second broadcasting signal from the second filter, and an amplifier amplifying a selected signal of the selector.

However, the known antenna switch circuit selects one broadcasting signal of the first broadcasting signal corresponding to the television broadcasting signal or the second broadcasting signal corresponding to the cable broadcasting signal by using the selector, but it may have the following problems.

Firstly, isolation between two broadcasting signals is bad.

Currently, a digital broadcast is broadcast by a current UHF band, while the analog broadcast is broadcast by a VHF band and a UHF band in the related art. Since cable television broadcasting is used in all frequency areas such as a VHF band and a UHF band, as described above, the antenna switch circuit is required in order to receive an air band and a cable signal by using a single tuner.

At this time, when one signal of different broadcasting signals is received, a high level of isolation is required so as to prevent interference in the received signals and additionally, the isolation between input terminals is defined by following values, as a condition defined in the FCC standard (FCC Part15 Section15.117) of North America.
54-216 MHz->80 dB
216-550 MHz->60 dB
550-806 MHz->55 dB

However, in the known antenna switch circuit, since the described isolation rule is not satisfied, currently, reception quality is deteriorated by interference between digital and analog television radio waves and cable television radio waves.

Secondly, the known antenna switch circuit does not appropriately correspond to the intensity of the selected broadcasting signal.

That is, input levels of the two different broadcasting signals are different. For example, the input level of the television signal is in the range of 20 dBuV to 100 dBuV and the input level of the cable signal is in the range of 0 dBmV±20 dBmV. In addition, since the input signal level of the television signal is largely changed, a low noise amplifier (LNA) is operated in a weak signal level and a bypass is performed when the input signal level is not weak, whereas the input signal level of the cable signal is only slightly changed, however it is easy to greatly distort the total power inputted into the input of the cable.

### SUMMARY OF THE INVENTION

An aspect of the present invention provides an antenna switch circuit and a method of switching the antenna capable of improving the isolation between two broadcasting signals in a television broadcast receiving system.

According to an aspect of the present invention, there is provided an antenna switch circuit including: a first filter passing a first broadcasting signal having a predetermined band among broadcasting signals passing through a first input terminal; a second filter passing a second broadcasting signal having a predetermined band among broadcasting signals passing through a second input terminal; a first amplifier amplifying or bypassing the first broadcasting signal of the first filter; a second amplifier amplifying or bypassing the second broadcasting signal of the second filter; and a signal level attenuator attenuating levels of the first broadcasting signal of the first amplifier and the second broadcasting signal of the second amplifier to have predetermined levels.

The first amplifier may be turned on or off and may include: a first low noise amplifier amplifying the first broadcasting signal of the first filter in a turn-on mode; and a first bypass switch which is turned off when the first low noise amplifier is turned on and is turned on when the first low noise amplifier is turned off by being disposed on a bypass path connected between an input terminal and an output terminal of the first low noise amplifier.

The second amplifier may be turned on or off and may include: a second low noise amplifier amplifying the second broadcasting signal of the second filter in a turn-on mode; and a second bypass switch which is turned off when the second low noise amplifier is turned on and is turned on when the second low noise amplifier is turned off by being disposed on a bypass path connected between an input terminal and an output terminal of the second low noise amplifier.

The antenna switch circuit may further include a switch controller supplying a switch control signal for turning the first bypass switch and the second bypass switch on or off in response to a first control signal by a broadcasting selection, respectively.

The antenna switch circuit may further include an amplifying controller supplying an amplifying control signal to the first low noise amplifier and the second low noise amplifier in response to a second control signal by the broadcasting selection, respectively.

The antenna switch circuit may further include a first input switch turned on or off in response to the amplifying control signal of the amplifying controller by being connected between the first filter and the first amplifier; and a second input switch turned on or off in response to the amplifying control signal of the amplifying controller by being connected between the second filter and the second amplifier.

The first input switch may be turned off when the second input switch is turned on and turned on when the second input switch is turned off.

Further, the antenna switch circuit may further include an output switch supplying one signal selected from an output signal of the first amplifier and an output signal of the second amplifier to the signal level attenuator.

The output switch may include: a first terminal connected to the output terminal of the first amplifier; a second terminal connected to the output terminal of the second amplifier; and a common terminal connected to the input terminal of the signal level attenuator, wherein the common terminal is connected to the first terminal or the second terminal in response to the amplifying control signal of the amplifying controller.

According to another aspect of the present invention, there is provided an antenna switch circuit including: a first filter passing a first broadcasting signal having a predetermined band among broadcasting signals passing through a first input terminal; a second filter passing a second broadcasting signal having a predetermined band among broadcasting signals passing through a second input terminal; a first input switch turning an output line connected to the output terminal of the first filter on or off; a second input switch turning an output line connected to the output terminal of the second filter on or off; a first amplifier amplifying or bypassing the first broadcasting signal of the first input switch; a second amplifier amplifying or bypassing the second broadcasting signal of the second input switch; an output switch selecting one of an output signal of the first amplifier and an output signal of the second amplifier; and a signal level attenuator attenuating a level of the broadcasting signal selected by the output switch to have a predetermined level, wherein the first amplifier includes: a first low noise amplifier turned on or off and amplifying the first broadcasting signal of the first filter in a turn-on mode; and a first bypass switch which is turned off when the first low noise amplifier is turned on and is turned on when the first low noise amplifier is turned off by being disposed on a bypass path connected between an input terminal and an output terminal of the first low noise amplifier, and the second amplifier includes: a second low noise amplifier turned on or off and amplifying the second broadcasting signal of the second filter in a turn-on mode; and a second bypass switch which is turned off when the second low noise amplifier is turned on and is turned on when the second low noise amplifier is turned off by being disposed on a bypass path connected between an input terminal and an output terminal of the second low noise amplifier.

The first input switch may be turned off when the second input switch is turned on and turned on when the second input switch is turned off.

The output switch may include: a first terminal connected to the output terminal of the first amplifier; a second terminal connected to the output terminal of the second amplifier; and a common terminal connected to the input terminal of the signal level attenuator, wherein the common terminal may be connected to the first terminal or the second terminal in response to the amplifying control signal of the amplifying controller.

The antenna switch circuit may further include a switch controller supplying a switch control signal for turning the first bypass switch and the second bypass switch on or off in response to a first control signal by a broadcasting selection, respectively.

The antenna switch circuit may further include an amplifying controller supplying an amplifying control signal to the first low noise amplifier, the second low noise amplifier, the first and second input switches, and the output switch in response to a second control signal by the broadcasting selection, respectively.

According to another aspect of the present invention, there is provided a method of switching an antenna including: filtering a signal by passing a first broadcasting signal having a predetermined band among broadcasting signals passing through a first input terminal through a first filter and by passing a second broadcasting signal having a predetermined band among broadcasting signals passing through a second input terminal through a second filter; amplifying a signal by amplifying or bypassing the first broadcasting signal of the first filter in a first amplifier and by amplifying or bypassing the second broadcasting signal of the second filter in a second amplifier; and attenuating a signal by attenuating levels of the first broadcasting signal of the first amplifier and the second broadcasting signal of the second amplifier to have predetermined levels in a signal attenuator.

The amplifying of the signal may include: determining whether the first low noise amplifier of the first amplifier is turned on or off; amplifying the first broadcasting signal of the first filter when the first low noise amplifier is turned on; and turning the first bypass switch off when the first low noise amplifier is turned on, and turning the first bypass switch on when the first low noise amplifier is turned off, the first bypass switch being disposed on a bypass path connected between the input terminal and the output terminal of the first low noise amplifier.

The amplifying of the signal may include: determining whether the second low noise amplifier of the second amplifier is turned on or off; amplifying the second broadcasting signal of the second filter when the second low noise amplifier is turned on; and turning the second bypass switch off when the second low noise amplifier is turned on, and turning the second bypass switch on when the second low noise amplifier is turned off, the second bypass switch being disposed on a bypass path connected between the input terminal and the output terminal of the second low noise amplifier.

The method of switching the antenna may further include: determining whether a first broadcast is selected or a second broadcast is selected; turning on a first input switch connected between the first filter and the first amplifier and turning a second input switch off, when the first broadcast is selected; and turning a second input switch connected between the second filter and the second amplifier and turning the first input switch off, when the second broadcast is selected.

The method of switching the antenna may further include selecting an output signal, and the selecting of the output signal may include: determining whether a first broadcast is selected or a second broadcast is selected; selecting the output signal of the first amplifier by the output switch and supplying the selected output signal to the signal level attenuator when the first broadcast is selected; and selecting the output signal of the second amplifier by the output switch and supplying the selected output signal to the signal level attenuator when the second broadcast is selected.

Further, the first broadcasting signal may be a ground wave broadcasting signal and the second broadcasting signal may be a cable broadcasting signal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an antenna switch circuit diagram according to a first exemplary embodiment of the present invention;

FIG. 2 is a circuit diagram of first and second input switches according to the first exemplary embodiment of the present invention;

FIG. 3 is a circuit diagram of an output switch according to the first exemplary embodiment of the present invention;

FIG. 4 is a flowchart illustrating a method of switching an antenna according to a second exemplary embodiment of the present invention;

FIG. 5 is a flowchart illustrating a first amplifying operation according to the second exemplary embodiment of the present invention;

FIG. 6 is a flowchart illustrating a second amplifying operation according to the second exemplary embodiment of the present invention;

FIG. 7 is a flowchart illustrating an input switching operation according to the second exemplary embodiment of the present invention; and

FIG. 8 is a flowchart illustrating an output switching operation according to the second exemplary embodiment of the present invention.

### DETAILED DESCRIPTION OF THE PREFERRED EMBODIMENT

Exemplary embodiments of the present invention will now be described in detail with reference to the accompanying drawings.

The present invention is not limited to the exemplary embodiments and the exemplary embodiments are used to help understanding the spirit of the present invention. Like reference numerals refer to like elements in the accompanying drawings.

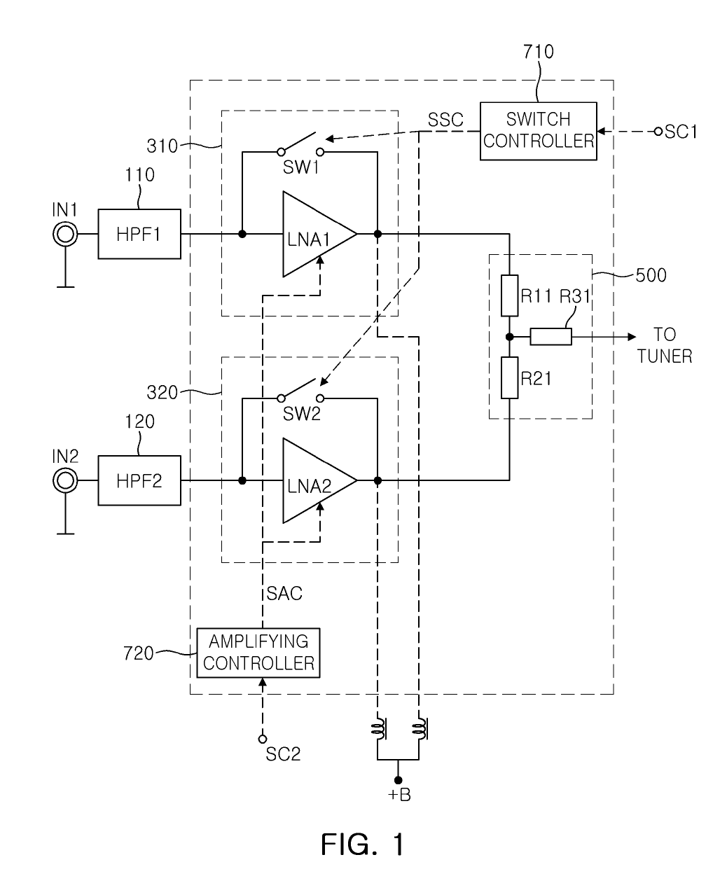

FIG. 1 is an antenna switch circuit diagram according to a first exemplary embodiment of the present invention.

Referring to FIG. 1, an antenna switch circuit according to first exemplary embodiment of the present invention may include: a first filter 110 through which a first broadcasting signal having a predetermined band among broadcasting signals passed through a first input terminal IN1 passes, a second filter 120 through which a second broadcasting signal having a predetermined band among broadcasting signals passed through a second input terminal IN2, a first amplifier 310 amplifying or bypassing the first broadcasting signal of the first filter 110, a second amplifier 320 amplifying or bypassing the second broadcasting signal of the second filter 120, and a signal level attenuator 500 attenuating levels of the first broadcasting signal of the first amplifier 310 and the second broadcasting signal of the second amplifier 320 to have predetermined levels.

Herein, the first broadcasting signal may be a ground wave broadcasting signal, the second broadcasting signal may be a cable broadcasting signal, and each of the first and second filters 110 and 120 passes a broadcasting signal having frequencies included in a frequency band of 54 MHz to 860 MHz therethrough.

That is, the first filter 110 interrupts a signal band of 5 MHz to 46 MHz and allows the ground wave broadcasting signal of 54 MHz or more to pass therethrough, and the second filter 120 interrupts the signal band of 5 MHz to 46 MHz and passes the cable broadcasting signal of 54 MHz or more therethrough.

Referring to FIG. 1, the first amplifier 310 is turned on or off and may include a first low noise amplifier LAN1 amplifying the first broadcasting signal of the first filter 110 in a turn-on mode, and a first bypass switch SW1 which is turned off when the first low noise amplifier LAN1 is turned on and is turned on when the first low noise amplifier LAN1 is turned off by being disposed on a bypass path connected between an input terminal and an output terminal of the first low noise amplifier LAN1.

The second amplifier 320 is turned on or off and may include a second low noise amplifier LAN2 amplifying the second broadcasting signal of the second filter 120 in a turn-on mode, and a second bypass switch SW2 which is turned off when the second low noise amplifier LAN2 is turned on and is turned on when the second low noise amplifier LAN2 is turned off by being disposed on a bypass path connected between an input terminal and an output terminal of the second low noise amplifier LAN2.

Further, referring to FIG. 1, the antenna switch circuit according to the first exemplary embodiment of the present invention may further include a switch controller 710 supplying a switch control signal SSC for turning each of the first bypass switch SW1 and the second bypass switch SW2 on or off in response to a first control signal SC1 by a broadcasting selection, and an amplifying controller 720 supplying an amplifying control signal SAC to each of the first low noise amplifier LNA1 and the second low noise amplifier LNA2 in response to a second control signal SC2 by the broadcasting selection.

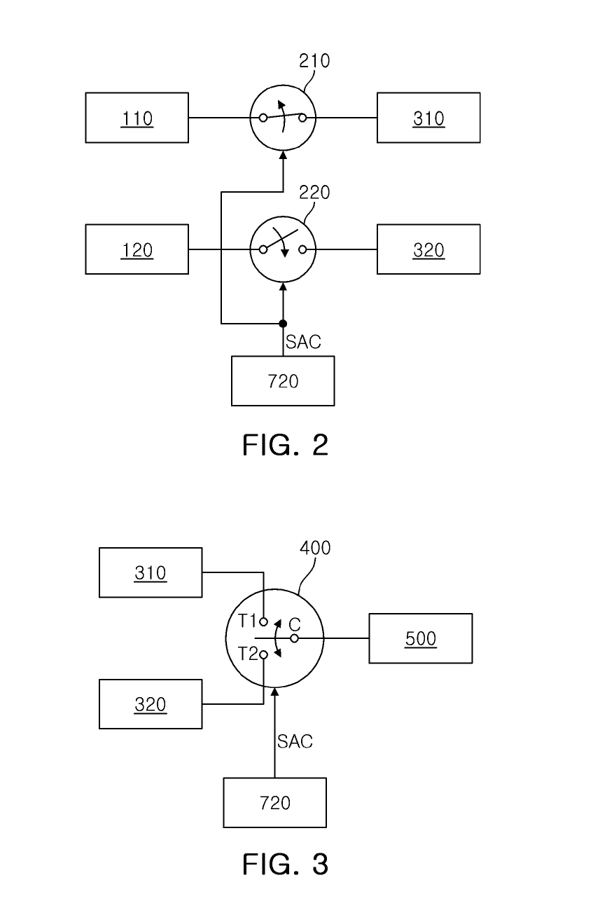

FIG. 2 is a circuit diagram of first and second input switches according to the first exemplary embodiment of the present invention.

Referring to FIG. 2, the antenna switch circuit according to the first exemplary embodiment of the present invention may further include a first input switch 210 turned on or off in response to the amplifying control signal of the amplifying controller 720 by being connected between the first filter 110 and the first amplifier 310, and a second input switch 220 turned on or off in response to the amplifying control signal of the amplifying controller 720 by being connected between the second filter 120 and the second amplifier 320.

Herein, the first input switch 210 may be turned off when the second input switch 220 is turned on, and turned on when the second input switch 220 is turned off.

FIG. 3 is a circuit diagram of an output switch according to the first exemplary embodiment of the present invention.

Referring to FIG. 3, the antenna switch circuit according to the first exemplary embodiment of the present invention may further include an output switch 400 selecting and supplying one signal selected from an output signal of the first amplifier 310 and an output signal of the second amplifier 320 to the signal level attenuator 500.

Herein, the output switch 400 may include a first terminal T1 connected to the output terminal of the first amplifier 310, a second terminal T2 connected to the output terminal of the second amplifier 320, and a common terminal C connected to the input terminal of the signal level attenuator 500, and may be provided to connect the common terminal C to the first terminal T1 or the second terminal T2 in response to the amplifying control signal of the amplifying controller 720.

Meanwhile, in the antenna switch circuit, the first broadcasting signal may be the ground wave broadcasting signal and the second broadcasting signal may be the cable broadcasting signal.

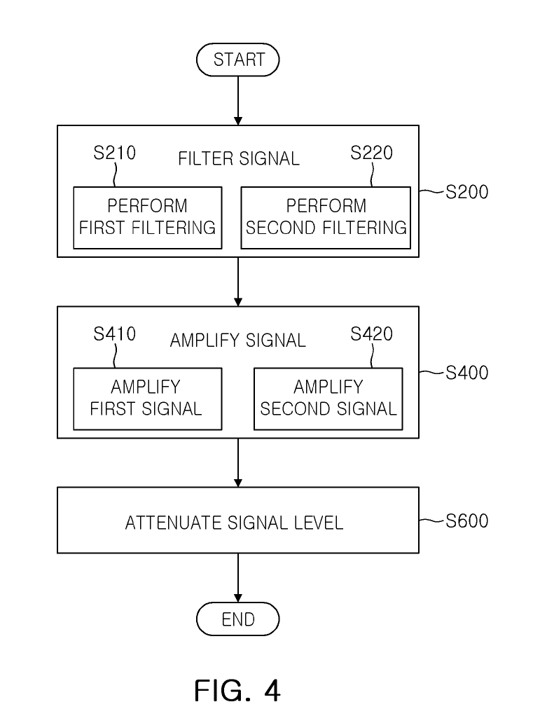

FIG. 4 is a flowchart illustrating a method of switching an antenna according to a second exemplary embodiment of the present invention.

Referring to FIG. 4, the method of switching the antenna according to the second exemplary embodiment of the present invention may include: filtering a signal in operation S200 including an operation S210 of passing through the first filter 110 a first broadcasting signal having a predetermined band among broadcasting signals passing through a first input terminal IN1, and an operation S220 of passing through the second filter 120 a second broadcasting signal having a predetermined band among broadcasting signals passing through a second input terminal IN2; amplifying a signal in operation S400 of amplifying or bypassing the first broadcasting signal of the first filter 110 by using a first amplifier 310, and of amplifying or bypassing the second broadcasting signal of the second filter 120 by using the second amplifier 320; and attenuating signals in operation S600 of attenuating signal levels of the first broadcasting signal of the first amplifier 310 and the second broadcasting signal of the second amplifier 320 to have predetermined levels by using the signal level attenuator 500.

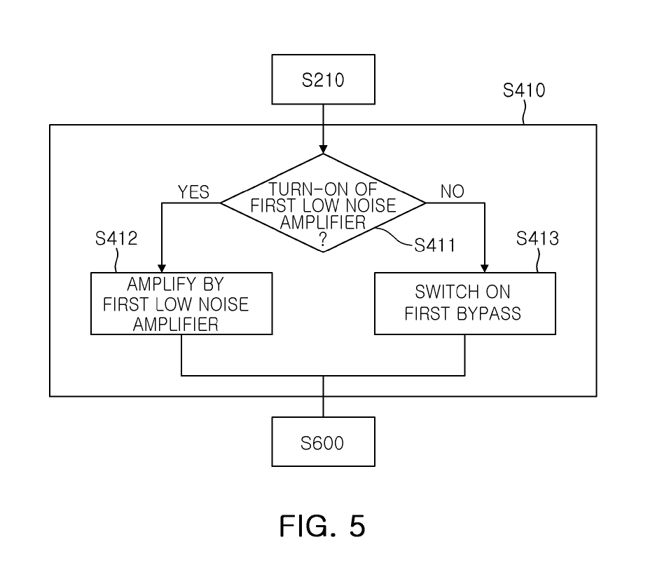

FIG. 5 is a flowchart illustrating a first amplifying operation according to the second exemplary embodiment of the present invention.

Referring to FIG. 5, the amplifying of the signal in the operation S400 may include: a first step in operation S411 of determining whether the first low noise amplifier LNA1 of the first amplifier 310 is turned on or off; a second step in operation S412 of amplifying the first broadcasting signal of the first filter 110 when the first low noise amplifier LNA1 is turned on; and a third step in operation S413 in which the first bypass switch SW1 disposed on the bypass path connected between the input terminal and the output terminal of the first low noise amplifier LNA1 is turned off when the first low noise amplifier LNA1 is turned on and turned on when the first low noise amplifier LNA1 is turned off.

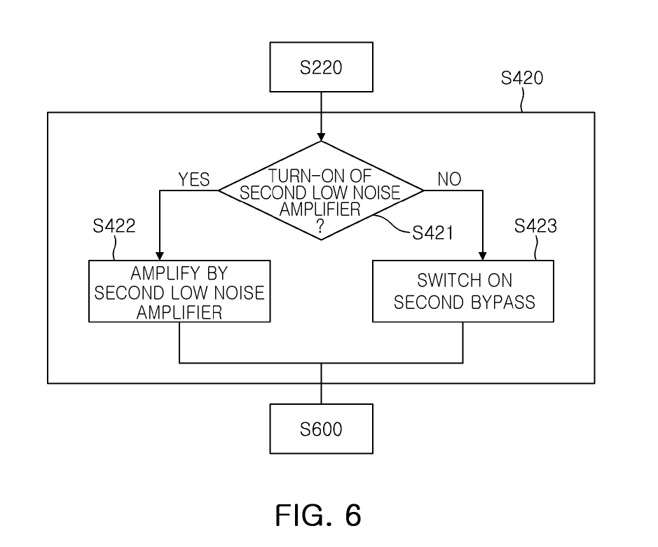

FIG. 6 is a flowchart illustrating a second amplifying operation according to the second exemplary embodiment of the present invention.

Referring to FIG. 6, the amplifying of the signal in the operation S400 may include: a first step in operation S421 of determining whether the second low noise amplifier LNA2 of the second amplifier 320 is turned on or off; a second step in operation S422 of amplifying the second broadcasting signal of the second filter 120 when the second low noise amplifier LNA2 is turned on; and a third step in operation S423 in which the second bypass switch SW2 disposed on the bypass path connected between the input terminal and the output terminal of the second low noise amplifier LNA2 is turned off when the second low noise amplifier LNA2 is turned on and turned on when the second low noise amplifier LNA2 is turned off.

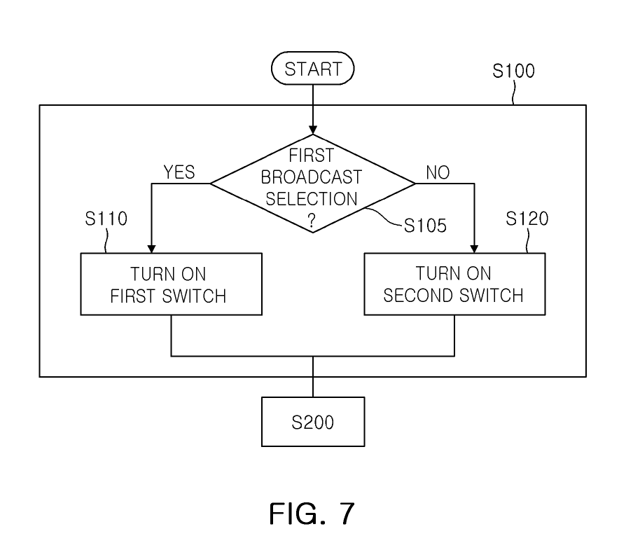

FIG. 7 is a flowchart illustrating an input switching operation according to the second exemplary embodiment of the present invention.

Referring to FIG. 7, the selecting of input signal in the operation S100 of the method of switching the antenna may further include a first step in operation S105 of determining whether a first broadcasting is selected or a second broadcasting is selected, a second step in operation S110 in which when the first broadcasting is selected, the first input switch 210 connected between the first filter 110 and the first amplifier 310 is turned on and the second input switch 220 is turned off, and a third step in operation S120 in which when the second broadcast is selected, the second input switch 220 connected between the second filter 120 and the second amplifier 320 is turned on and the first input switch 210 is turned off.

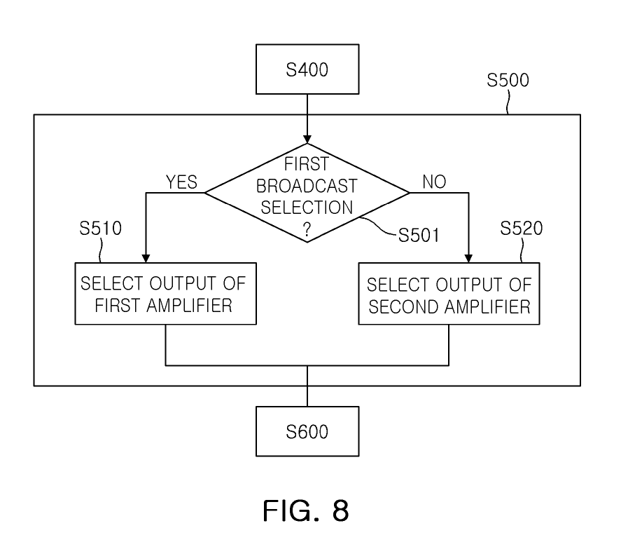

FIG. 8 is a flowchart illustrating an output switching operation according to a second exemplary embodiment of the present invention.

Referring to FIG. 8, the method of switching the antenna may further include selecting an output signal in operation S500, and the selecting of the output signal in operation S500 may further include a first step in operation S501 of determining whether a first broadcast is selected or a second broadcast is selected, a second step in operation S510 in which the output switch 400 selects the output signal of the first amplifier 310 and supplies the selected output signal to the signal level attenuator 500 when the first broadcasting is selected, and a third step in operation S520 in which the output switch 400 selects the output signal of the second amplifier 320 and supplies the selected output signal to the signal level attenuator 500 when the second broadcast is selected.

Further, in the method of switching the antenna according to the embodiment of the present invention, the first broadcasting signal may be the ground wave broadcasting signal and the second broadcasting signal may be the cable broadcasting signal.

Hereinafter, operations and effects according to the embodiment of the present invention will be described referring to the accompanying drawings.

To describe the antenna switch circuit according to the first exemplary embodiment of the present invention with reference to FIGS. 1 to 3, in the antenna switch circuit according to the first exemplary embodiment of the present invention shown in FIG. 1, the first broadcasting signal is the ground wave broadcasting signal and the second broadcasting signal is the cable broadcasting signal, and hereinafter, the case when ground wave broadcast is selected and the case when the cable broadcast is selected will be described, respectively.

First, the case when ground wave broadcast is selected will be described.

Referring to FIG. 1, the first filter 110 supplies an ground wave broadcasting signal corresponding to a first broadcasting signal having a predetermined band among broadcasting signals passing through first input terminal IN1 to first amplifier 310. Herein, the first filter 110 may interrupt a signal band of 5 MHz to 46 MHz and allow the ground wave broadcasting signal of 54 MHz or more to pass therethrough.

Further, the second filter 120 supplies a cable broadcasting signal corresponding to second broadcasting signal having a predetermined band among broadcasting signals passing through second input terminal IN2 to second amplifier 320. Herein, the second filter 120 may interrupt a signal band of 5 MHz to 46 MHz and allow the cable broadcasting signal of 54 MHz or more to pass therethrough.

Referring to FIGS. 1 and 2, in using the first and second input switches 210 and 220, when the ground wave broadcast is selected, the first input switch 210 is turned on and the second input switch 220 is turned off.

At this time, the first filter 110 allows ground wave broadcasting signal corresponding to first broadcasting signal having a predetermined band among broadcasting signals passing through first input terminal IN1 to pass through the first input switch 210, and the first input switch 210 supplies the ground wave broadcasting signal to the first amplifier 310.

Meanwhile, the second filter 120 allows cable broadcasting signal corresponding to second broadcasting signal having a predetermined band among broadcasting signals passing through second input terminal IN2 to pass through the second input switch 220, but since the second input switch 220 is turned off, the cable broadcasting signal is interrupted by the second input switch 220.

As such, in using the first and second input switches 210 and 220, the interference can be decreased by improving the isolation characteristic between the ground wave broadcasting signal and the cable broadcasting signal.

Thereafter, referring to FIG. 1, when the ground wave broadcast is selected, the first amplifier 310 operates and outputs the signal, but the second amplifier 320 does not operate and thus does not output the signal.

At this time, the first amplifier 310 may amplify or bypass the first broadcasting signal of the first filter 110 according to a level of the inputted ground wave broadcasting signal. Herein, a detector detecting the level of the ground wave broadcasting signal is not shown, but the signal level may be easily detected by a well-known method, like a method using detection information of the signal level such as a received signal strength indicator (RSSI) and the like.

The first amplifier 310 may be constituted by the first low noise amplifier LNA1 and the first bypass switch SW1, and when the level of the ground wave broadcasting signal needs to be amplified, the first low noise amplifier LNA1 is turned on and the first bypass switch SW1 is turned off, such that the first low noise amplifier LNA1 may supply the ground wave broadcasting signal to the signal level attenuator 500 by amplifying the ground wave broadcasting signal to have a predetermined gain.

Thereafter, the signal level attenuator 500 appropriately controls the level of the ground wave broadcasting signal by attenuating the level of the first broadcasting signal of the first amplifier 310 to have a predetermined level, such that a signal distortion in a next stage can be prevented.

Referring to FIG. 3, in using the output switch 400, the output switch 400 may select the output signal of the first amplifier 310 and supply the selected output signal to the signal level attenuator 500.

As such, in using the output switch 400, the interference can be decreased by improving the isolation characteristic between the ground wave broadcasting signal and the cable broadcasting signal.

Meanwhile, as shown in FIG. 1, the antenna switch circuit according to the first exemplary embodiment of the present invention may include a switch controller 710 and an amplifying controller 720.

The switch controller 710 may turn on the first bypass switch SW1 and turn off the second bypass switch SW2 by supplying the switch control signal SSC in response to a first control signal SC1 by a broadcasting selection, when the ground wave broadcast is selected.

Herein, when the amplification is required because of a relatively low level of the ground wave broadcasting signal, the switch controller 710 may turn off the first bypass switch SW1.

In addition, the amplifying controller 720 may turn on the first low noise amplifier LNA1 and turn off the second low noise amplifier LNA2 by supplying an amplifying control signal SAC in response to a second control signal SC2 by the broadcasting selection, when the ground wave broadcast is selected.

Herein, when the amplification is not required because of a relatively high level of the ground wave broadcasting signal, the amplifying controller 720 may turn off the first low noise amplifier LNA1.

Next, the case where the cable broadcast is selected will be described.

Referring to FIG. 1, the first filter 110 may supply ground wave broadcasting signal corresponding to first broadcasting signal having a predetermined band among broadcasting signals passing through first input terminal IN1 to the first amplifier 310. Herein, the first filter 110 may interrupt a signal band of 5 MHz to 46 MHz and allow the ground wave broadcasting signal of 54 MHz or more to pass therethrough.

Further, the second filter 120 may supply cable broadcasting signal corresponding to second broadcasting signal having a predetermined band among broadcasting signals passing through second input terminal IN2 to the second amplifier 320. Herein, as described above, the second filter 120 may interrupt a signal band of 5 MHz to 46 MHz and allow the cable broadcasting signal of 54 MHz or more to pass therethrough.

In the case that the first and second input switches 210 and 220 are used with reference to FIG. 2, when the cable broadcast is selected with reference to FIGS. 1 and 2, the first input switch 210 is turned off and the second input switch 220 is turned on.

At this time, the second filter 120 may allow cable broadcasting signal corresponding to a second broadcasting signal having a predetermined band among broadcasting signals passing through second input terminal IN2 to pass through the second input switch 220, and the second input switch 220 may supply the cable broadcasting signal to the second amplifier 320.

However, the first filter 110 may supply ground wave broadcasting signal corresponding to first broadcasting signal having a predetermined band among broadcasting signals passing through first input terminal IN1 to the first input switch 210, but since the first input switch 210 is turned off, the ground wave broadcasting signal is interrupted by the first input switch 210.

As such, in the case the first and second input switches 210 and 220 are used, the interference can be decreased by improving the isolation characteristic between the ground wave broadcasting signal and the cable broadcasting signal.

Thereafter, referring to FIG. 1, when the cable broadcast is selected, the second amplifier 320 operates and outputs the signal, but the first amplifier 310 does not operate and thus does not output the signal. As such, the reason that the amplifier for each ground wave broadcast and each cable broadcast is provided is because of different characteristics that in the ground wave broadcast, a deviation in the signal levels is large according to regions and in the cable broadcast, a deviation in the signal levels is not large because signals are transmitted by the cable.

At this time, the second amplifier 320 may amplify or bypass the second broadcasting signal of the second filter 120 according to a level of the inputted cable broadcasting signal. Herein, a detector detecting the level of the cable broadcasting signal is not shown, but the signal level may be easily detected by a well-known method.

The second amplifier 320 may be constituted by the second low noise amplifier LNA2 and the second bypass switch SW2, and when the level of the cable broadcasting signal needs to be amplified, the second low noise amplifier LNA2 is turned on and the second bypass switch SW2 is turned off, such that the second low noise amplifier LNA2 may supply the ground wave broadcasting signal to the signal level attenuator 500 by amplifying the ground wave broadcasting signal to have a predetermined gain.

Thereafter, the signal level attenuator 500 appropriately controls the level of the cable broadcasting signal by attenuating the level of the second broadcasting signal of the second amplifier 320 to have a predetermined level, such that a signal distortion in a next stage can be prevented.

Referring to FIG. 3, in the case the output switch 400 is used, the output switch 400 may select the output signal of the second amplifier 320 and supply the selected output signal to the signal level attenuator 500.

As such, in the case of using the output switch 400, the interference can be decreased by improving the isolation characteristic between the ground wave broadcasting signal and the cable broadcasting signal.

Meanwhile, as shown in FIG. 1, the antenna switch circuit according to the first exemplary embodiment of the present invention may include a switch controller 710 and an amplifying controller 720.

The switch controller 710 may turn the second bypass switch SW2 on and turn the first bypass switch SW1 off by supplying the switch control signal SSC in response to a first control signal SC1 by a broadcasting selection, when the cable broadcast is selected.

Herein, when the amplification is required because of the relatively low level of the cable broadcasting signal, the switch controller 710 may turn off the second bypass switch SW2.

In addition, the amplifying controller 720 may turn the second low noise amplifier LNA2 on or off and may turn the first low noise amplifier LNA1 off by supplying an amplifying control signal SAC in response to a second control signal SC2 by the broadcasting selection, when the cable broadcast is selected.

Herein, when the amplification is not required because of a relatively high level of the cable broadcasting signal, the amplifying controller 720 may turn off the second low noise amplifier LNA2.

Hereinafter, method of switching antenna according to the second exemplary embodiment of the present invention will be described with respect to FIGS. 1 to 8.

Referring to FIGS. 1 to 4, in the method of switching the antenna according to the second exemplary embodiment of the present invention, in the filtering of the signal in operation S200, a first filter 110 may allow a first broadcasting signal having a predetermined band among broadcasting signals passing through a first input terminal IN1 to pass therethrough, and a second filter 120 may allow a second broadcasting signal having a predetermined band among broadcasting signals passing through a second input terminal IN2 to pass therethrough.

Next, in the amplifying of the signal in operation S400, a first amplifier 310 may amplify or bypass the first broadcasting signal of the first filter 110 and a second amplifier 320 may amplify or bypass the second broadcasting signal of the second filter 120.

Thereafter, in the attenuating of the signal in operation S600, a signal level attenuator 500 may attenuate levels of the first broadcasting signal of the first amplifier 310 and the second broadcasting signal of the second amplifier 320 to have predetermined levels.

Referring to FIGS. 1 to 5, in the amplifying of the signal in operation S400, the first step as operation S411 in first signal amplification operation S410 may be performed to determine whether the first low noise amplifier LNA1 of the first amplifier 310 is turned on or off.

Next, the second step as operation S412 in the operation S410 may be performed to amplify the first broadcasting signal of the first filter 110 when the first low noise amplifier LNA1 is turned on.

Thereafter, in the third step as operation S413 in the operation 410, the first bypass switch SW1 disposed on the bypass path connected between the input terminal and the output terminal of the first low noise amplifier LNA1 may be turned off when the first low noise amplifier LNA1 is turned on and may be turned on when the first low noise amplifier LNA1 is turned off.

Referring to FIGS. 1 to 6, in the amplifying of the signal in operation S400, the first step as operation S421 in the second signal simplification operation S420 may determine whether the second low noise amplifier LNA2 of the second amplifier 320 is turned on or off.

Next, the second step as operation S422 in the second signal simplification operation S420 may amplify the second broadcasting signal of the second filter 120 when the second low noise amplifier LNA2 is turned on.

Thereafter, in the third step as operation S423 in the second signal amplification operation S420, the second bypass switch SW2 disposed on the bypass path connected between the input terminal and the output terminal of the second low noise amplifier LNA2 may be turned off when the second low noise amplifier LNA2 is turned on and may be turned on when the second low noise amplifier LNA2 is turned off.

Referring to FIGS. 1, 2 and 7, in the method of switching the antenna, the first step as operation S105 for selecting the input signal may be performed to determine whether a first broadcast is selected or a second broadcast is selected.

Next, in the second step as operation S110 for selecting the input signal, when the first broadcast is selected, the first input switch 210 connected between the first filter 110 and the first amplifier 310 may be turned on and the second input switch 220 may be turned off.

Thereafter, in the third step as operation S120 for selecting the input signal, when the second broadcast is selected, the second input switch 220 connected between the second filter 120 and the second amplifier 320 may be turned on and the first input switch 210 may be turned off.

Referring to FIGS. 1, 3 and 8, in the method of switching the antenna, the first step as operation S501 of the selecting of the output signal in operation S500 may be performed to determine whether a first broadcast is selected or a second broadcast is selected.

Next, in the second step as operation S510 of the selecting of the output signal in operation S500, the output switch 400 may select the output signal of the first amplifier 310 and may supply the selected output signal to the signal level attenuator 500 when the first broadcast is selected.

Thereafter, in the third step as operation S520 in the operation 500 of selecting the output signal, the output switch 400 may select the output signal of the second amplifier 320 and supply the selected output signal to the signal level attenuator 500 when the second broadcast is selected.

In the method of switching the antenna according to the embodiment of the present invention, the first broadcasting signal may be the ground wave broadcasting signal and the second broadcasting signal may be the cable broadcasting signal.

According to embodiments of the present invention as described above, a receiving sensitivity can be significantly ensured and the lowest signal distortion can be ensured by improving the isolation characteristic between the ground wave broadcast and the cable broadcast and controlling the switching operation and the amplifying operation according to the selection of the ground wave broadcast and the cable broadcast, respectively.

As set forth above, according to various exemplary embodiments of the present invention, in the television broadcast receiving system, a receiving sensitivity can be significantly ensured and a signal distortion can be decreased by improving the isolation between two broadcasting signals and appropriately processing the signal according to the intensity of the broadcasting signal.

While the present invention has been shown and described in connection with the exemplary embodiments, it will be apparent to those skilled in the art that modifications and variations can be made without departing from the spirit and scope of the invention as defined by the appended claims. Accordingly, the scope of the present invention will be determined by the appended claims.

What is claimed is:

1. An antenna switch circuit, comprising:
a first filter allowing a first broadcasting signal having a predetermined band among broadcasting signals passing through a first input terminal to pass therethrough;
a second filter allowing a second broadcasting signal having a predetermined band among broadcasting signals passing through a second input terminal to pass therethrough;
a first amplifier amplifying or bypassing the first broadcasting signal of the first filter;
a second amplifier amplifying or bypassing the second broadcasting signal of the second filter; and
a signal level attenuator attenuating levels of the first broadcasting signal of the first amplifier and the second broadcasting signal of the second amplifier to have predetermined levels.

2. The antenna switch circuit of claim 1, wherein the first amplifier is turned on or off and includes:
a first low noise amplifier amplifying the first broadcasting signal of the first filter in a turn-on mode; and
a first bypass switch turned off when the first low noise amplifier is turned on and is turned on when the first low noise amplifier is turned off by being disposed on a bypass path connected between an input terminal and an output terminal of the first low noise amplifier.

3. The antenna switch circuit of claim 2, wherein the second amplifier is turned on or off and includes:
a second low noise amplifier amplifying the second broadcasting signal of the second filter in the turn-on mode; and
a second bypass switch turned off when the second low noise amplifier is turned on and is turned on when the second low noise amplifier is turned off by being disposed on a bypass path connected between an input terminal and an output terminal of the second low noise amplifier.

4. The antenna switch circuit of claim 3, further comprising a switch controller supplying a switch control signal for turning the first bypass switch and the second bypass switch on or off in response to a first control signal by a broadcasting selection, respectively.

5. The antenna switch circuit of claim 4, further comprising an amplifying controller supplying an amplifying control signal to the first low noise amplifier and the second low noise amplifier in response to a second control signal by the broadcasting selection, respectively.

6. The antenna switch circuit of claim 5, further comprising:
a first input switch turned on or off in response to the amplifying control signal of the amplifying controller by being connected between the first filter and the first amplifier; and
a second input switch turned on or off in response to the amplifying control signal of the amplifying controller by being connected between the second filter and the second amplifier.

7. The antenna switch circuit of claim 6, wherein the first input switch is turned off when the second input switch is turned on and turned on when the second input switch is turned off.

8. The antenna switch circuit of claim 5, further comprising an output switch supplying one signal selected from an output signal of the first amplifier and an output signal of the second amplifier to the signal level attenuator.

9. The antenna switch circuit of claim 8, wherein the output switch includes: a first terminal connected to the output terminal of the first amplifier; a second terminal connected to the output terminal of the second amplifier; and a common terminal connected to the input terminal of the signal level attenuator, the common terminal being connected to the first terminal or the second terminal in response to the amplifying control signal of the amplifying controller.

10. The antenna switch circuit of claim 1, wherein the first broadcasting signal is a ground wave broadcasting signal and the second broadcasting signal is a cable broadcasting signal.

11. An antenna switch circuit, comprising:
a first filter allowing a first broadcasting signal having a predetermined band among broadcasting signals passing through a first input terminal to pass therethrough;
a second filter allowing a second broadcasting signal having a predetermined band among broadcasting signals passing through a second input terminal to pass therethrough;
a first input switch turning an output line connected to the output terminal of the first filter on or off;
a second input switch turning an output line connected to the output terminal of the second filter on or off;
a first amplifier amplifying or bypassing the first broadcasting signal of the first input switch;
a second amplifier amplifying or bypassing the second broadcasting signal of the second input switch;
an output switch selecting one of an output signal of the first amplifier and an output signal of the second amplifier; and
a signal level attenuator attenuating a level of the broadcasting signal selected by the output switch to have a predetermined level,
wherein the first amplifier includes:
a first low noise amplifier turned on or off and amplifying the first broadcasting signal of the first filter in a turn-on mode; and
a first bypass switch turned off when the first low noise amplifier is turned on and is turned on when the first low noise amplifier is turned off by being disposed on a bypass path connected between an input terminal and an output terminal of the first low noise amplifier, and
the second amplifier includes:
a second low noise amplifier turned on or off and amplifying the second broadcasting signal of the second filter in a turn-on mode; and
a second bypass switch turned off when the second low noise amplifier is turned on and is turned on when the second low noise amplifier is turned off by being disposed on a bypass path connected between an input terminal and an output terminal of the second low noise amplifier.

12. The antenna switch circuit of claim 11, wherein the first broadcasting signal is a ground wave broadcasting signal and the second broadcasting signal is a cable broadcasting signal.

13. The antenna switch circuit of claim. 12, wherein the first input switch is turned off when the second input switch is turned on and turned on when the second input switch is turned off.

14. The antenna switch circuit of claim. 12, wherein the output switch includes: a first terminal connected to the output terminal of the first amplifier; a second terminal connected to the output terminal of the second amplifier; and a common terminal connected to the input terminal of the signal level attenuator, the common terminal being connected to the first terminal or the second terminal in response to the amplifying control signal of the amplifying controller.

15. The antenna switch circuit of claim 12, further comprising: a switch controller supplying a switch control signal for turning the first bypass switch and the second bypass switch on or off in response to a first control signal by a broadcasting selection, respectively.

16. The antenna switch circuit of claim 15, further comprising an amplifying controller supplying an amplifying control signal to the first low noise amplifier, the second low noise amplifier, the first and second input switches, and the output switch in response to a second control signal by the broadcasting selection, respectively.

17. A method of switching an antenna, comprising:
filtering a signal by passing a first broadcasting signal having a predetermined band among broadcasting signals passing through a first input terminal through a first filter, and by passing a second broadcasting signal having a predetermined band among broadcasting signals passing through a second input terminal through a second filter;
amplifying a signal by amplifying or bypassing the first broadcasting signal of the first filter in a first amplifier, and by amplifying or bypassing the second broadcasting signal of the second filter in a second amplifier; and
attenuating a signal by attenuating levels of the first broadcasting signal of the first amplifier and the second broadcasting signal of the second amplifier to have predetermined levels in a signal level attenuator.

18. The method of switching the antenna of claim 17, wherein the amplifying of the signal includes:
determining whether the first low noise amplifier of the first amplifier is turned on or off;
amplifying the first broadcasting signal of the first filter when the first low noise amplifier is turned on; and
turning the first bypass switch off when the first low noise amplifier is turned on, and turning the first bypass switch on when the first low noise amplifier is turned off, the first bypass switch being disposed on a bypass path connected between the input terminal and the output terminal of the first low noise amplifier.

19. The method of switching the antenna of claim 17, wherein the amplifying of the signal includes:
determining whether the second low noise amplifier of the second amplifier is turned on or off;
amplifying the second broadcasting signal of the second filter when the second low noise amplifier is turned on; and
turning the second bypass switch off when the second low noise amplifier is turned on, and turning the second bypass switch on when the second low noise amplifier is turned off, the second bypass switch being disposed on a bypass path connected between the input terminal and the output terminal of the second low noise amplifier.

20. The method of switching the antenna of claim 17, further comprising:
determining whether a first broadcast is selected or a second broadcast is selected;
turning on a first input switch connected between the first filter and the first amplifier and turning a second input switch off, when the first broadcast is selected; and
turning on a second input switch connected between the second filter and the second amplifier and turning the first input switch off, when the second broadcast is selected.

21. The method of switching the antenna of claim 17, further comprising selecting an output signal,
wherein the selecting of the output signal includes:
determining whether a first broadcast is selected or a second broadcast is selected;
selecting the output signal of the first amplifier by the output switch and supplying the selected output signal to the signal level attenuator when the first broadcast is selected; and
selecting the output signal of the second amplifier by the output switch and supplying the selected output signal to the signal level attenuator when the second broadcast is selected.

22. The method of switching the antenna of claim 17, wherein the first broadcasting signal is a ground wave broadcasting signal and the second broadcasting signal is a cable broadcasting signal.
